(19) United States
(12) Patent Application Publication
(10) Pub. No.: US 2007/0084859 A1
(43) Pub. Date: Apr. 19, 2007

(54) Utensil for conventional heating and microwave heating

(76) Inventor: Min-Ching Chen, Changhua City (TW)

Correspondence Address: CHARLES E. BAXLEY, ESQ., 90 JOHN STREET, THIRD FLOOR, NEW YORK, NY, 10038, US

(21) Appl. No.: 11/240,107

(22) Filed: Sep. 30, 2005

(51) Int. Cl. H05B 6/80

(52) U.S. Cl. 219/725

(57) ABSTRACT

A utensil for conventional heating and microwave heating comprises a base coated with a microwave absorbing coating made of refractory material. The base of the utensil is made of metal and the microwave absorbing coating has a high thermal conductivity. The body of the utensil is fully or partially coated with the microwave absorbing coating. The microwave absorbing coating can absorb thermal energy of a conventional heating oven or can absorb the microwaves of a microwave heating oven, and then turn the microwaves into heat energy and transmit the heat energy to the base of the utensil, thus heating the food from outside in.

### BACKGROUND OF THE INVENTION

1. Field of the Invention

The present invention relates to a utensil for receiving food, and more particularly to a utensil that is suitable both for microwave heating and non-microwave heating.

2. Description of the Prior Art

A utensil for conventional baking oven is normally made of metal because of its high thermal conductivity. However, the metal made utensil cannot be used in a microwave oven, because the microwave can't penetrate the metal utensil and will be reflected by the surface of the metal utensil, and there is a danger of explosion as a result of arc light effect caused during the cause of microwave reflection. Therefore, a microwave-heating utensil is usually made of polypropylene, Poly-4-methylpentene-1 plastic, glass or ceramic. A family must prepare different utensils differently for conventional heating and microwave heating, and definitely, too many utensils will not only cost a lot of money but also will occupy a lot of space.

In addition, during microwave cooking, the microwaves will penetrate the food and heat the food is heated from the inside out, so that the water will be evaporated out of the food, so that the food will get hard after microwave cooking.

The present invention has arisen to mitigate and/or obviate the afore-described disadvantages.

### SUMMARY OF THE INVENTION

The primary objective of the present invention is to provide a utensil that is suitable both for microwave heating and non-microwave heating.

A utensil for conventional heating and microwave heating comprises a base coated with a microwave absorbing coating made of refractory material. The base of the utensil is made of metal and the microwave absorbing coating has a high thermal conductivity. The body of the utensil is fully or partially coated with the microwave absorbing coating. The microwave absorbing coating can absorb thermal energy of a conventional heating oven or can absorb the microwaves of a microwave heating oven, and then turn the microwaves into heat energy and transmit the heat energy to the base of the utensil, thus heating the food from outside in.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a cross sectional view of a utensil in accordance with the present invention;

FIG. 2 is an illustrative view of showing that the utensil of the present invention is heated in a microwave oven;

FIG. 3 shows that the utensil of FIG. 2 is covered with a lid;

FIG. 4 is an illustrative view of showing that the utensil of the present invention is heated in a conventional (non-microwave) heating oven;

FIG. 5 shows that the utensil of FIG. 4 is covered with a lid;

FIG. 6 is an illustrative view of showing that the body of the utensil of the present invention is partially coated with microwave absorbing coating;

FIG. 7 shows a utensil of different size and shape in accordance with the present invention.

### DETAILED DESCRIPTION OF THE PREFERRED EMBODIMENTS

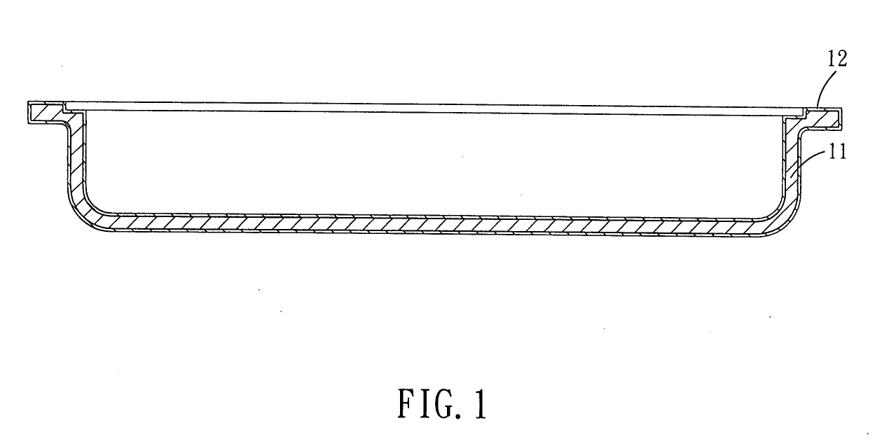

Referring to FIG. 1, a utensil for conventional heating and microwave heating in accordance with the present invention is shown and comprises a base 11 made of metal. On the surface of the base 11 is coated with a microwave absorbing coating 12 that is made of refractory material having high thermal conductivity.

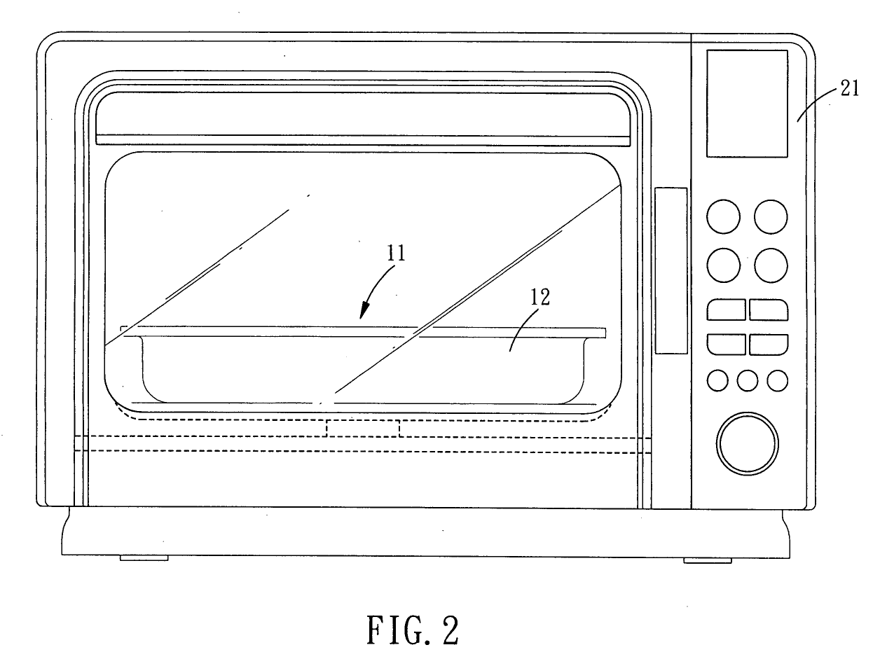

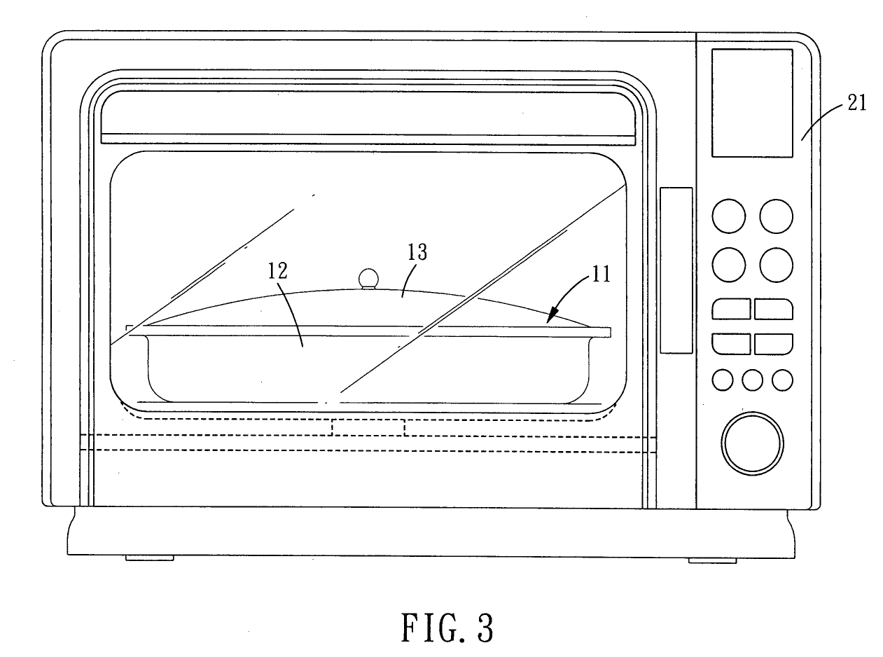

When the base 11 is heated in a microwave oven 21, as shown in FIG. 2, the microwaves will be absorbed and converted into thermal energy by the microwave absorbing coating 12, and then the thermal energy will be transmitted to the base 11. In this way, the base 11 will collect the thermal energy to heat the food from the outside in the same way as a conventional baking oven, keeping the food fresh and tasty. The base 11 also can be covered with a lid 13 so as to speed up the heating process, as shown in FIG. 3.

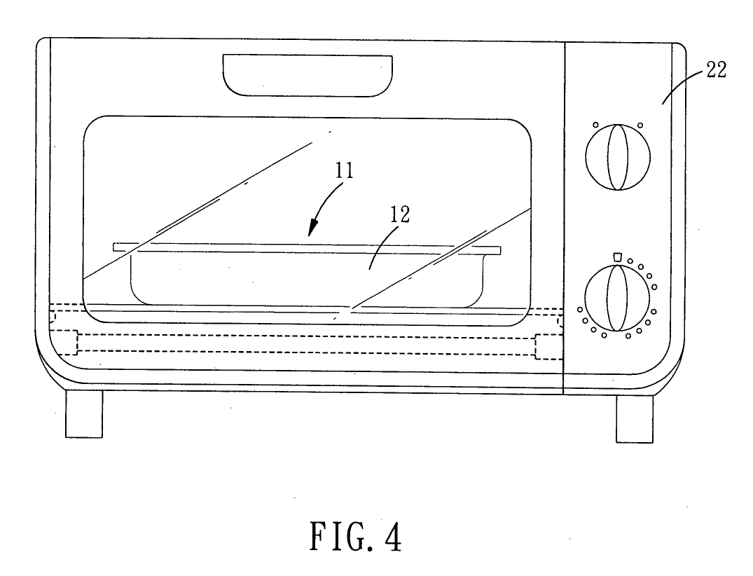

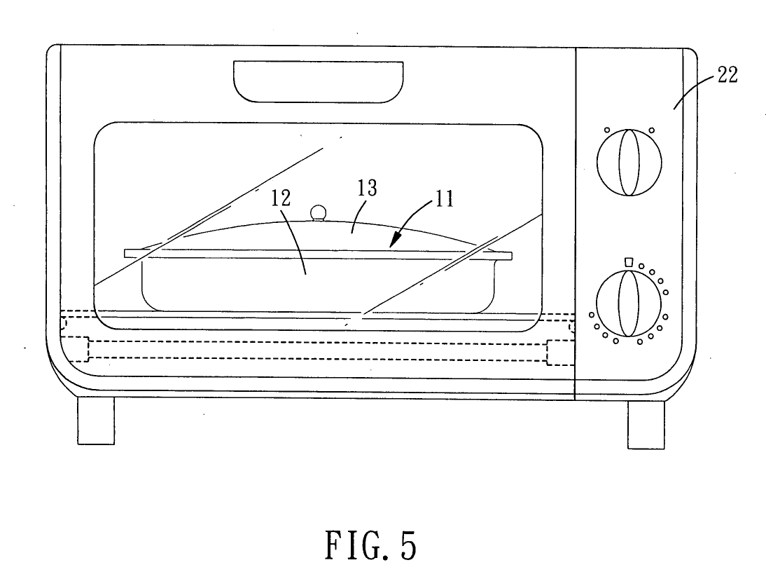

In addition, the utensil of the present invention also can be used in a conventional baking oven 22 (non-microwave heating oven), as shown in FIG. 4, and the base 11 also can be covered with a lid 13 so as to speed up the heating process, as shown FIG. 5. The base 11 itself has good thermal conductivity, during the heating process, the microwave absorbing coating 12 will absorb the thermal energy and transmit it to the base 11, and the base 11 will heat the food from the outside. Therefore, the present invention is also suitable for conventional non-microwave baking oven 22.

The utensil in accordance with the present invention is suitable for both microwave heating and non-microwave heating. In addition to this, the base 11 is made of metal, it can collect the thermal energy more quickly, thus speeding up the heating process.

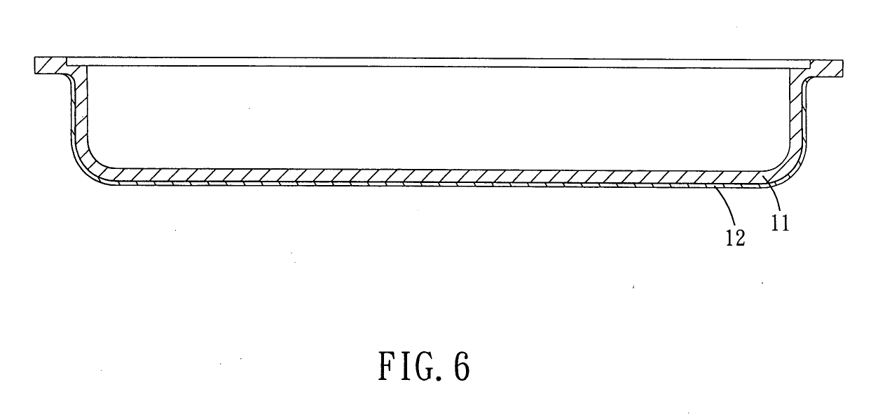

In the abovementioned embodiment, the whole surface of the base 11 is entirely coated with the microwave absorbing coating 12. However, the microwave absorbing coating 12 also can cover only a part of (the outer surface) the base 11, and the base 11 partially coated must be covered with the lid 13 during heating process(as shown in FIG. 6) for prevention of the accidents of sparkles or explosions caused by microwave-reflection.

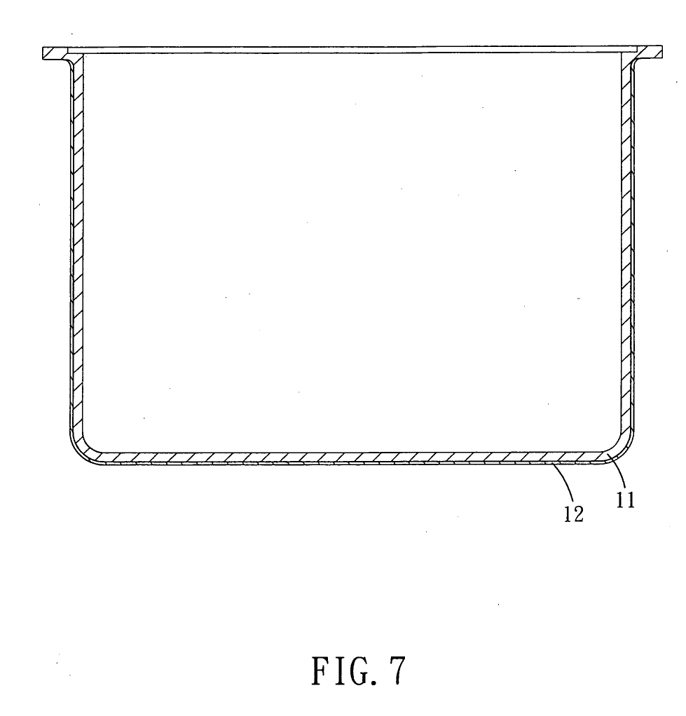

In addition, the body 11 of the utensil can be varied in depth and shape, as shown in FIG. 7.

While we have shown and described various embodiments in accordance with the present invention, it should be clear to those skilled in the art that further embodiments may be made without departing from the scope of the present invention.

What is claimed is:

1. A utensil for conventional heating and microwave heating comprising a base coated with a microwave absorbing coating made of refractory material, the microwave absorbing coating can absorb energy of a heat source and transmit the energy to the base of the utensil, so that food inside the body will be heated.

2. The utensil for conventional heating and microwave heating as claimed in claim 1, wherein the base of the utensil is made of metal.

3. The utensil for conventional heating and microwave heating as claimed in claim 1, wherein the microwave absorbing coating has a high thermal conductivity.

4. The utensil for conventional heating and microwave heating as claimed in claim 1, wherein the body of the utensil is fully coated with the microwave absorbing coating.

5. The utensil for conventional heating and microwave heating as claimed in claim 1, wherein the body of the utensil is partially coated with the microwave absorbing coating.

6. The utensil for conventional heating and microwave heating as claimed in claim 1, wherein the microwave absorbing coating can absorb microwaves of a microwave heating device.

7. The utensil for conventional heating and microwave heating as claimed in claim 1, wherein the microwave absorbing coating can absorb thermal energy of a conventional heating device.
